(19) United States
(12) Patent Application Publication
(10) Pub. No.: US 2004/0051733 A1
(43) Pub. Date: Mar. 18, 2004

(54) Method and system for parental internet control

(76) Inventor: David Katzir, Reut (IL)

Correspondence Address: MARSTELLER & ASSOCIATES, P O BOX 803302, DALLAS, TX, 75380-3302, US

(21) Appl. No.: 10/451,855

(22) PCT Filed: Dec. 17, 2001
(86) PCT No.: PCT/IL01/01212

(30) Foreign Application Priority Data
Dec. 28, 2000 (IL) 140624

(51) Int. Cl. G09G 5/00

(52) U.S. Cl. 345/741

(57) ABSTRACT

The present invention relates to a method and system for carrying out Parental Control when browsing the Internet by means of a computer, which comprises: (a) Providing a Parental Control application; (b) Providing in said parental control application several setups, each setup including predefined restrictions for accessing Internet sites or Web pages; (c) Providing at least two mouse components, each mouse component having its unique ID; (d) Associating with each mouse component one or more of said setups; (e) When operating the computer for browsing the Internet, activating said Parental Control application; (f) Retrieving by said application the ID of the mouse component connected; and (g) Activating by said application the setup associated with the ID of said mouse component, thereby activating its corresponding Internet access restrictions.

### FIELD OF THE INVENTION

The invention relates to a method and system for providing parental control over use of the Internet. More particularly, the invention relates to a method and system for parental control in which the mouse of the computer assumes an important role in restricting access to selected sites.

### BACKGROUND OF THE INVENTION

The rapid expansion of the Internet has created a problem for parents who wish to restrict access of their computer to certain types of Internet sites.

The Internet has, on the one hand, increased the freedom of expression by enabling Internet sites to offer material that essentially cannot be controlled or censored, but on the other hand, it has created a problem in that it is essentially impossible to control or limit access to specific types of materials that are offered by Internet sites, particularly sites catering to adults only.

The term “Parental control” refers to the ability to control the Internet content accessible via a specific computer. For example, there exist programs for preventing sites that meet specific criteria from being accessed by a specific computer. These programs are useful for those who cannot supervise their computer all the time. Such programs could be used for censorship, but also as tools to be used at the user's discretion.

Some browsers, such as the Internet Explorer 5, provide a parental control software. It helps the user to control the types of content that his computer can access on the Internet. The user can adjust the types of content other people can view, with or without his permission. He also can override content settings on a case-by-case basis. Moreover, the user can set up a list of Web sites that other people can never view, regardless of how the sites' contents are rated, and set up a list of Web sites always accessible, again regardless of content rating.

Cyber Patrol (www.cyberpatrol.com) is another Parental Control program. Cyber Patrol controls access from any computer to the Internet. Using this program, the access to the Internet can be restricted at the client level. It is an Internet access management utility that also manages application usage from a PC. It allows parents or teachers to manage computer use in their own household or classroom. Cyber Patrol loads during start-up and runs in the background to control access to applications or Internet sites.

In the above-mentioned examples, the Parental Control is subject to the user's profile. Two or more levels are determined—the “parent” level, and the “child” level(s). The parent can set up and alter the Internet access to restricted sites. Although the default setup may be the “child” level, the parent still has to be careful not to leave the computer unattended in the “parent” level, and hence, operating according to this Parent Control scheme is both inconvenient and inefficient. Some Parental Control requires entering a password in order to operate in the “parental mode”, and this has its drawbacks, such as the need to remember it, which is inconvenient. Furthermore, the password is entered only once, and the checking as to the user's identity is not continuous.

Another drawback is that sometimes the parent does not remember at what level he left the computer unattended, and when passing nearby, when his child uses the computer or even when the computer is off, there is no clear indication for him at what level the computer is, or in what level it will operate when next turned on.

In another aspect, chatting by means of the Internet may cause significant problems for children and their parents. A well known problem is the abuse of children by adults via chatting. When these adults are caught, they frequently claim that they did not know that they were chatting with a child. Therefore, when the user of the computer is a child, it is another object of the invention to send to hischatting party a clear warning message that he is chatting with a child. Then, if the adult abuses the child and is caught, he can no longer claim that he didn't know the age of his chatting party.

It is therefore an object of the present invention to provide a method and system for Parental Control, in which the user need not type the user-name nor the password.

It is another object of the present invention to provide a method and system for Parental Control, wherein access levels are predefined and the suitable access level is selected automatically according to the one currently using the computer.

It is a further object of the present invention to provide a method and system for Parental Control, upon which the current user identity is easily distinguished.

It is still another object of the invention to provide a method and system for Parental Control, upon which the control level is checked periodically during the computer operation according to the user's identity.

It is a still further object of the present invention to provide a method and system for parental Internet access control, upon which the parent is provided with a clear indication external to the computer by which he can determine in which Parental Control level the computer is active, or moreover, even if the computer is off, he can determine which Parental Control level is active.

It is a still further object of the present invention to provide a method and system for parental Internet access control, suitable for operation by children.

It is a still further object of the invention to provide a warning to an adult chat partner that he is chatting with a child.

It is a still further object of the present invention to provide a noticeable indication which restriction setup is used.

It is a still further object of the invention to provide to a remote user, communicating with the current user of the system, the exact age of the current user.

Other objects and advantages of the invention will become apparent as the description proceeds.

### SUMMARY OF THE INVENTION

The present invention relates to a method for carrying out Parental Control when browsing the Internet by means of a computer, which comprises: (a) Providing a Parental Control application; (b) Providing in the parental control application several setups, each setup including predefined restrictions for accessing Internet sites or Web pages; (c) Providing at least two mouse components, each mouse component having its unique ID; (d) Associating with each mouse component one or more of the setups; (e) When operating the computer for browsing the Internet, activating the Parental Control application; (f) Retrieving by the application the ID of the mouse component connected; and (g) Activating by the application the setup associated with the ID of the mouse component, thereby activating its corresponding Internet access restrictions.

According to one embodiment of the invention the Parental Control application is a module of the Internet browser. According to another embodiment of invention the Parental Control application is a module separate from the Internet browser.

Preferably, the ID of the mouse component is a unique ID stored in a memory storage within the mouse.

According to one embodiment of the invention the first of said at least two mouse component is given to a parent, and a second is given to a child. In that case, the setup associated with the ID of the parent mouse component includes less restrictions than those in the setup of the child's mouse, or null restrictions.

Preferably the mouse component is a mouse, wherein the parent's mouse differs in shape and/or color from the child's mouse.

Preferably the differences in shape and/or color between the parent's mouse and the child mouse are so significant as to be easily noticed even from a considerable distance.

Preferably, the ability to define the restrictions in the setups is restricted, such as by the requirement to provide a password.

Preferably the associating of setups to a mouse ID is restricted, such as by the requirement to provide a password.

In order to increase the efficiency of the method of the invention, the mouse of the parent should be kept in a safe place inaccessible to the child when not in use.

The invention further relates to a system for carrying out parental control which comprises a parental control application, and at least two mouse components.

Preferably, the parental control application comprises several setups, each setup including predefined restrictions for accessing Internet sites or Web pages.

According to one embodiment of the invention, the mouse component comprises an ID and the parental control application comprises software means for retrieving said ID. In one embodiment of the invention the mouse component is a mouse.

Preferably, each mouse comprises a first plug to which a second plug in the cable leading to the computer is connected, the first plug is located within the case of the mouse. Alternatively, the first plug may be located external to the mouse casing, several centimeters therefrom, a data cable connecting between said first plug and the mouse.

Preferably, the method of the invention further comprises the steps of: (a) Defining a “child” user according to the ID of the mouse component he uses; (b) Determining when a chat session is activated by said “child” user; and (c) Sending a message to the chat partner of said “child” user to warn him that he is chatting with a child.

Preferably the system of the invention further comprises: (a) Means in the parental application for defining a “child” user; (b) A warning message for warning a chat partner that he is chatting with a child; (c) A module within the parental application for determining when a chat session is activated by the “child” user, and for sending the warning to the chat partner when such session is found active.

According to one embodiment of the invention, the warning message is a predefined message being an integral part of the parental control application. Preferably the warning message is a message which is predefined by an adult user of the computer.

In another embodiment of the invention, when the mouse components are at least one UIDMs connectable to the mouse system of the computer, the method of the invention further comprises: (a) each UIDM having its unique ID; (b) Associating with each UIDM one or more of the setups; (c) When operating the computer for browsing the Internet, activating the Parental Control application; (d) Retrieving by the application the ID of the UIDM connected to the mouse of the computer; and (e) Activating by the application the setup associated with the ID of the UIDM, thereby activating its Internet access restrictions.

Preferably a UIDM is given to a parent, and said UIDM being connected to the mouse only when the parent is working on the computer, and removed at other times. Preferably, the most restricted setup is activated when no UIDM is connected to the mouse.

According to one embodiment of the invention, the mouse system further comprises a light indicator that lights when a UIDM is connected to the mouse system or alternatively lights when a UIDM is not connected to the mouse system.

Preferably, the associating of setups to a UIDM ID is restricted, such as by the requirement to provide a password.

Preferably the UIDM is connected by inserting it into a slot within the mouse system. According to one embodiment of the invention, the mouse system comprises a mouse connectable to the computer and a slot, wherein the UIDM is connectable to said slot within the mouse. According to another embodiment of the invention, the mouse system comprises a mouse and an identification box connectable to the mouse and computer, and the UIDM is connectable to a slot within the identification box. According to a further embodiment of the invention, the UIDM is connected by inserting it into a slot within a mouse pad.

Preferably the system of the invention comprises a parental control application, and at least one UIDM connectable to the mouse system of the computer.

Preferably the UIDM comprises an ID and the parental control application comprises software means for retrieving said ID.

The invention further relates to a method for carrying out Security Control when browsing the Internet by means of a computer, which comprises: (a) Providing a Security Control application; (b) Providing in the Security control application several setups, each setup including predefined restrictions for accessing data from a computer; (c) Providing at least one UIDM connectable to the mouse system of the computer, each UIDM having its unique ID; (d) Associating with each UIDM one or more of the setups; (e) When operating the computer, activating said Security Control application; (f) Retrieving by the application the ID of the UIDM connected to the mouse system of the computer; and (g) Activating by the Security Application the setup associated with the ID of the UIDM, thereby activating the security restrictions associated with the UIDM.

Preferably different UIDMs are given to different users, and the UIDM is connected to the mouse system only when the user is working on the computer, and removed at other times.

The invention further relates to a system for carrying out security control which comprises a security control application, and at least one UIDM connectable to the mouse system of the computer. Preferably the security control application comprises several setups, each setup including predefined restrictions for accessing data from the computer.

Preferably the UIDM comprises an ID and the security control application comprises software means for retrieving the ID.

Preferably the age of the user is recorded within the mouse component, which can be retrieved from the mouse component by a remote application with which the user is remotely connected.

### BRIEF DESCRIPTION OF THE DRAWINGS

FIG. 1 illustrates in block diagram form the structure of a Parental Control system, according to the prior art;

FIG. 2 illustrates in block diagram form the components of a Parental Control system, according to one embodiment of the invention;

FIG. 3 illustrates a mouse controlling system, according to one embodiment of the invention;

FIG. 4 illustrates a mouse designed for children, according to one embodiment of the invention;

FIG. 5 is a flow diagram illustrating a process for defining a setup in a Parental Control application, according to one embodiment of the invention;

FIG. 6 schematically illustrates a high level flowchart of a process for initiating a Parental Control scheme, according to one embodiment of the invention;

FIG. 7 illustrates a GUI form for defining the Parental control scheme, according to one embodiment of the invention;

FIGS. 8a and 8b illustrate a mouse that comprises a socket according to one embodiment of the invention;

FIG. 9 is a flow diagram describing a process for warning a chat partner that he is chatting with a child;

FIG. 10 illustrates a mouse comprising one electronic card, on which the ID is stored within its circuitry, according to one embodiment of the present invention;

FIG. 11 illustrates a circuit for indicating the presence of the parental UIDM in a mouse, according to one embodiment of the invention;

FIG. 12 schematically illustrates an “identification” box, according to one embodiment of the invention;

FIG. 13 schematically illustrates in a flowchart form an age verification sequence, according to one embodiment of the invention; and

FIG. 14 schematically illustrates a mouse pad with UIDM reading capability, according to another embodiment of the invention.

### DETAILED DESCRIPTION OF PREFERRED EMBODIMENTS

In order to facilitate the reading of the description to follows, a number of terms employed in the art are defined below:

USB (Universal Serial Bus) is a “plug and play” interface between computer and add-on devices (such as audio players, joysticks, keyboards, telephones, scanners, and printers). With USB, a new device can be added to a host computer without having to add an adapter card or even having to turn the computer off. The USB peripheral bus standard was developed by Compaq, IBM, DEC, Intel, Microsoft, NEC, and Northern Telecom and the technology is available without charge for all computer and device vendors.

A UART is the microchip with programming that controls a computer's interface to its attached serial devices. Specifically, it provides the computer with the RS-232C Data Terminal Equipment (Data Terminal Equipment) interface so that it can “talk” to and exchange data with modems and other serial devices.

RS-232C is a long-established standard (“C” is the current version) that describes the physical interface and protocol for relatively low-speed serial data communication between computers and related devices.

A GUI (Graphical User Interface) is used to refer to software applications that are easier to use than their text-based predecessors. GUI programs use icons, toolbars, taskbars and other friendly, point-and-click functions.

A SIM (Subscriber Identity Module) is a card inserted into GSM phones that contains the telephone account information of a user. It lets a user to use a borrowed or rented GSM phone as if it were your own. According to the invention, a card similar to the SIM is used, said card is connected to the mouse of the computer.

In order to prevent forbidden Web pages from being accessed by the user, prior art Parental Control programs implement “filtering” methods. Some of the filtering methods used in the art are:

Checking the content of a Web page: Prior to the presentation of a Web page by the Web browser, the browser searches for forbidden predefined words and their synonyms in the Web page. Whenever such words are detected, in which Web page the browser does not display the Web page. The words can be searched in the Web address, as well.

Web search: Whenever a user carries out a Web search, the browser may add some conditions, such that the Web search will not find the Web sites containing forbidden words. For example, when searching for Web sites according to the keyword “MOVIE”, the browser may alter the searching string “MOVIE” to “(MOVIE) AND NOT (SEX) AND NOT (XXX)”, wherein XXX indicates any one or more forbidden words.

Restriction of Web addresses: The access to predefined Web addresses may be restricted. For example, if the parent wishes to restrict the access to the Web address (www.hardcore.com), then whenever the browser tries to access this Web address or its derivatives (such as www.hardcore.com/couples.htm), the browser displays a message indicating that the access to this URL (Uniform Resource Location, i.e. a Web address) is forbidden.

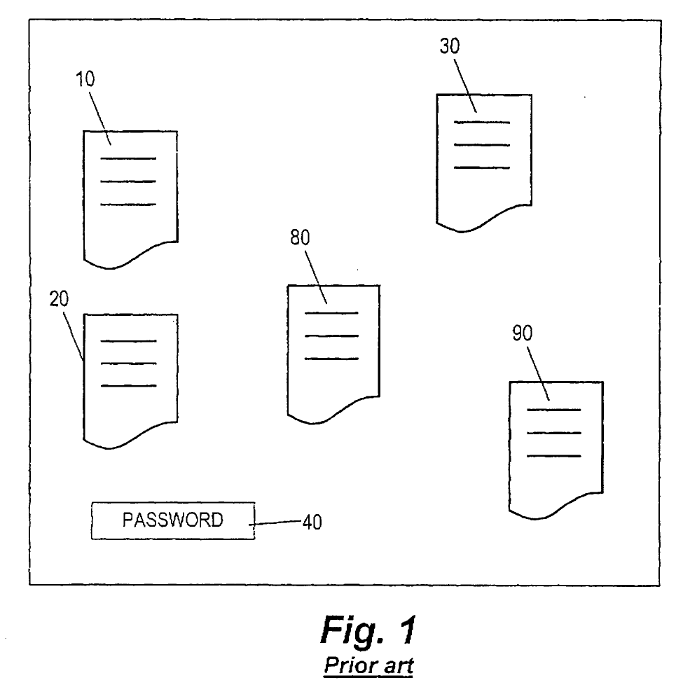

FIG. 1 schematically illustrates in block diagram form the structure of a Parental Control system, according to the prior art. The components are:

A list of categories 30. The categories may define a control level, such as “Sex”, “Nudity”, etc. Each category is comprised of a list of keywords 10, comprising words the presence of which in a Web page or address indicates that the Web page should not be displayed; a list of Web sites 20, comprising forbidden Web sites; and a list of ratings 80. The predetermined rating in the list is compared with the rating as given to the site and accordingly access and display of pages may be allowed or not. Any other restricting rules 90 may exist. The user can establish a predetermined setup as provided by the browser, and can add and alter any setup according to his wish.

Optionally, the access to the Parental Control setup can be restricted or not by a password 40.

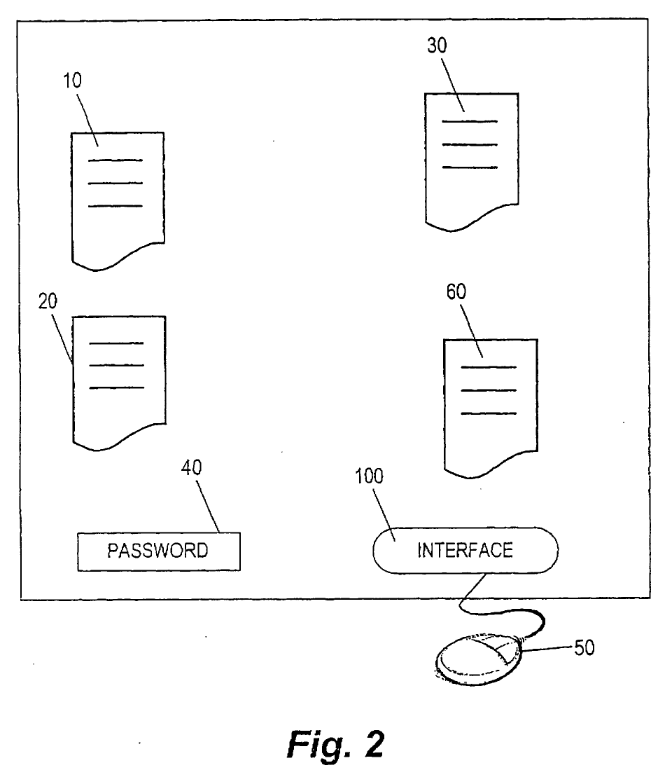

FIG. 2 schematically illustrates a block diagram of the components in the Parental Control system, according to one embodiment of the invention. In addition to the components described in FIG. 1, the system includes the mouse 50 of the computer that comprises an ID retrievable by the computer to which it is attached. The retrieval of the ID is carried out by means of interface 100. Preferably, in addition to the ID, specific mouse types are given specific color and shapes, according to the age of the user. The system comprises also a list of IDs 60, and a specific combination of parameters from the lists 10, 20 and 30, that is associated with each of the IDs. Each combination can be defined generally by the parent using the computer and is called herein a “setup”.

The interface 100 may be a part of a Parental Control software, or a separate module. One of its operations is to retrieve an ID from the mouse. It is recommended that the retrieval be carried out periodically, in order to set or change the parental control level upon the replacement of the mouse attached to the computer system.

The parents should keep their mouse in a safe place away from the children. According to the invention, different mouse types are given to different users. For example, in one family there may exist two mouses, one for the parents, and another for the children. The mouse of the parents should have a different ID and preferably different shape and color than the mouse of the children.

The ID of the mouse is used for identifying the user. Hence, the profile (setup) of the current user is associated with the ID of the mouse. Whenever the attached mouse does not comprise an ID, or the ID is not familiar to the Parental Control system of the invention, the most restricted categories (or setup) are activated.

Using a mouse as identification means results in some benefits as compared to the prior art:

No password with the attendant inconveniences is required;

Forgetting a password is more probable than losing a mouse;

Parental Control restrictions are activated even upon leaving the computer unattended, according to the type of mouse connected to the computer;

The active Parental configuration can be ascertained by a glance, since it is associated with a certain mouse, usually one distinctly different in shape and/or color from others. For example, as the mouse of the child is made in a specific shape and color, the parent can easily determine what Parental Control level is activated.

According to the prior art, the PC mouse controlling system has the following parts: Sensors, mouse controller, communication link, interface, and driver. Sensors are the movement detectors that sense the mouse movement and button switches, which sense the button states. The mouse controller within the mouse reads the state of those sensors and takes account of current mouse position. When this information changes the mouse controller sends a packet of data to the computer interface via the mouse driver.

The mouse driver receives that data packet and decodes the information from it and acts according to the information. Typically, the mouse driver conveys information regarding the mouse position and button states, and provides it to the application. Typically, the mouse driver calls mouse cursor moving routines when the mouse is moved and sends messages to the software when buttons are pressed.

According to an embodiment of the invention, the ID of the mouse is periodically retrieved by interface 100.

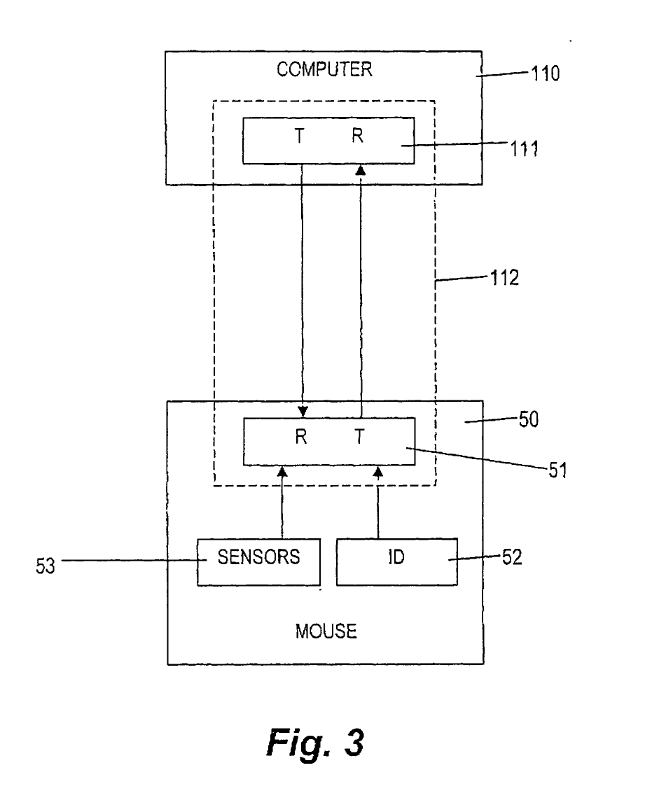

FIG. 3 schematically illustrates a mouse controlling system, according to one embodiment of the invention. Mouse 50 is connected to the computer 110 by the serial interface 112 (such as RS-232C). The communication is carried out by two transmitting chips (such as UARTs) 111 (on the computer side) and 51 (on the mouse side). The transmitting chip 51 can receive input from the sensors 53 or from the ID storage means 52.

According to another embodiment of the invention, the ID may be conveyed to the application by means of USB, when such option exists in the computer.

There are several options for conveying the ID from the mouse to the computer. According to a first option, the ID may be conveyed upon retrieving the call from the Parental Control application. According to a second option, the ID is conveyed periodically. According to a third option, the ID is conveyed to the computer any time that the mouse is moved, in addition to the displacement information.

The parental control can be implemented as a software module/utility or as a part of the Web browser. The programming environment of the browser “Internet Explorer 5” provides functions for controlling and monitoring the browser's operation. Using such software means enables development of a separate software application that can “hook” Web pages before their presentation. A more sophisticated application can filter not only Web pages, but also any other Web service, such as FTP (File Transfer Protocol) and e-mail.

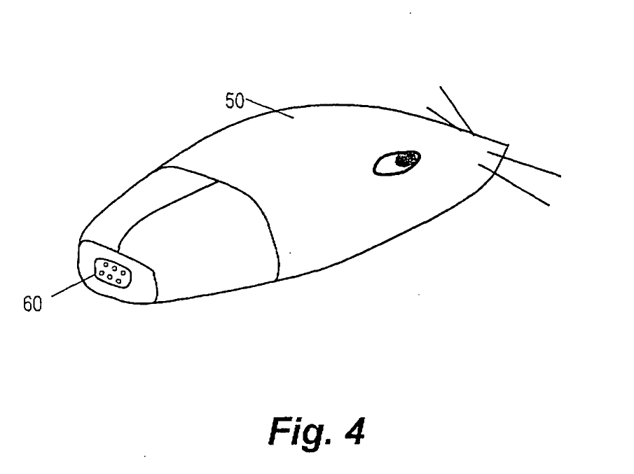

FIG. 4 illustrates a mouse designed for a child, according to one embodiment of the invention. Due to its special design and/or color, a parent can note at a glance if the active Parental Control setup is the “parent” setup or a “child” setup. As said, it is preferable that the mouse of the child be different in shape and/or color from the mouse of the parent's mouse.

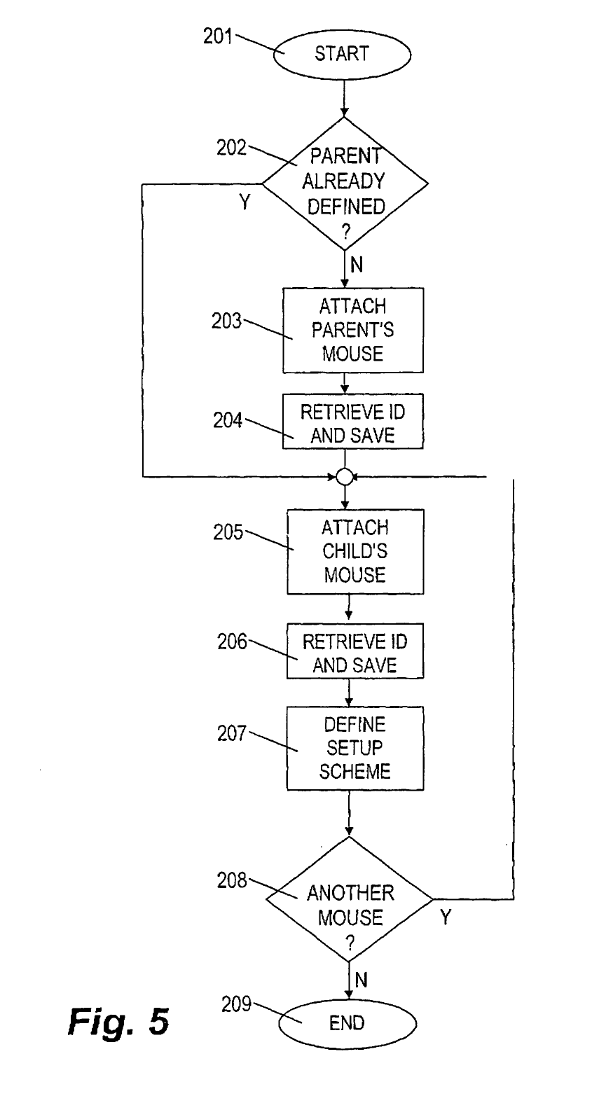

FIG. 5 is a flow diagram illustrating a process for defining the setup for a parent/child scheme in a Parental Control application, according to one embodiment of the invention.

At step 201, the process starts, by executing the setup program/utility.

At 202, if the “parent” has already been defined, the process continues with step 205, otherwise, step 203.

At 203, the user is told (by the program/utility) to attach the parent's mouse. The user attaches the parent's mouse to the computer.

At 204, the software retrieves the ID of the parent's mouse and saves it in a memory location.

At 205, the user is asked to attach the child's mouse to the computer.

At 206, the ID of the child's mouse is retrieved by the program/utility and saved.

At 207, the user is asked to define the setup to be associated with the ID of child's mouse as saved in step 206.

At 208, the user is asked if he wishes to define the setup associated with an additional mouse. If the answer is “Yes”, the process returns to step 205. If however the answer is “No”, the process continues with step 209, where the process for defining mouse setups ends.

A specific setup is thus associated with each specific mouse, and therefore the Parental Control application “knows” which setup to activate, according to the connected mouse.

Since a mouse can be lost or even broken, a password may be used as a substitute for the ID of the mouse of the parent. Of course, the password can be used as an additional security means.

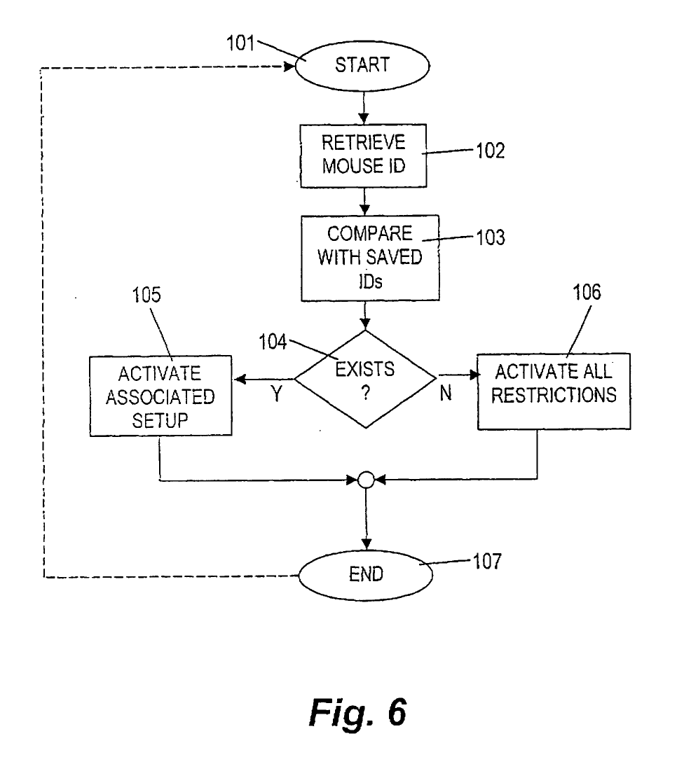

FIG. 6 is a flow diagram illustrating a process of Parental Control, according to one embodiment of the invention. It should be noted that upon turning on the computer, the Parental Control application is activated automatically, and it works in the background as long as the computer is on, or at least as long as the browser is on. Those skilled in the art will appreciate that there are a variety of ways to invoke the Parental Control application.

At 101, the process starts.

At 102, the ID of the mouse is retrieved.

At 103, the retrieved ID is compared with the list of IDs as saved in the Parental Control application.

At 104, if the ID is determined to be on said list, the process continues to step 105, in which the setup associated with that ID is activated. Otherwise, if the ID is not found in said list, the process continues with step 106, where the Parental Control application activates all the restrictions defined in all the various setups.

At 107, the process ends.

It should be noted that the process illustrated in FIG. 6 is performed periodically, for example, every 1 to 3 minutes.

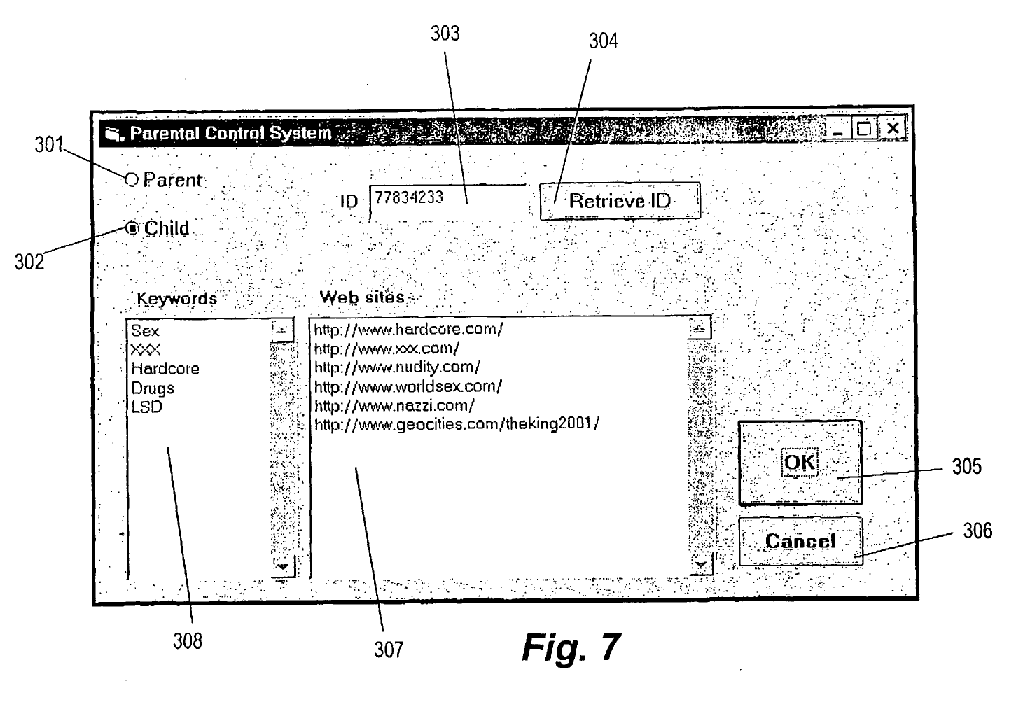

FIG. 7 schematically illustrates an exemplary GUI form for defining the Parental Control scheme, according to an embodiment of the invention. Entry to the GUI form is restricted by a password (not shown) or presence of the parent's mouse, enabling access only to the parent.

Two levels of operation may be defined: The Parent level and the Child level. Selecting the Parent level is carried out by clicking the radio button 301, and selecting the Child level is carried out by clicking the radio button 302. This way, more than one mouse can be set to operate in the Parent level.

The keywords upon which a Web page is deemed forbidden are included in box 308, and may be edited by the user. The forbidden Web sites are included in box 308, and may also be edited by the user.

Whenever the user wishes to define the setup of a mouse, he attaches the mouse to the computer, and clicks on button 304. As a result, the ID of the mouse appears on text box 303. If the mouse ID was already defined, then its associated keywords and Web sites are loaded and shown in text boxes 308 and 307, so he may alter the content.

Upon clicking the OK button 305, the altered setup is stored. Upon clicking the Cancel button 306, the system returns the old definitions associated with the attached ID of the mouse.

Those skilled in the art will appreciate that there are many variations to a GUI for defining and altering the setup. For example, in order to help a parent set up the Parental Control parameters, software for Parental Control may comprise some predefined setups, such as those existing in Internet Explorer 5. The parent may select one of the predefined setups, and alter the parameters according to his preferences.

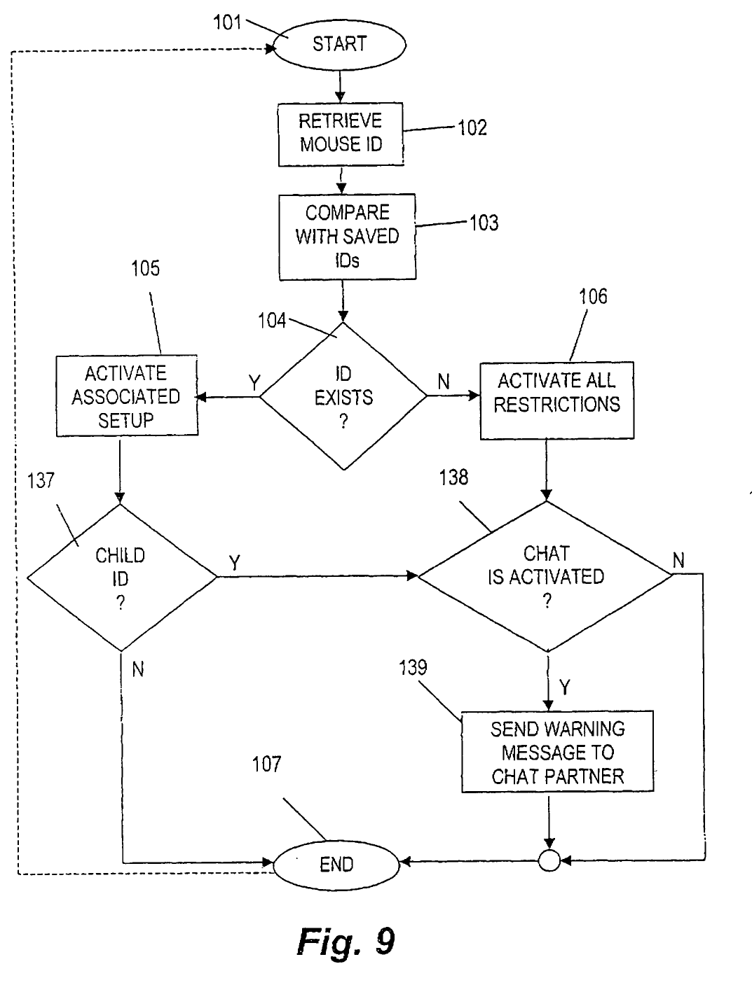

In another aspect, the act of chatting by means of the Internet has created a significant problem to parents. There are many reported cases of child abuse by adults using Internet chat lines. Afterwards, when such an abuser is caught, in many cases he claims that while chatting he was unaware that hispartner was underage. The present invention provides a solution to this problem. FIG. 9 shows a block diagram illustrating this solution. Blocks in this scheme, which are identical to blocks in FIG. 6 and have a same numeric indication, perform essentially the same function. As previously discussed, the invention provides means for the parental control application to know anytime whether an adult or a child is working on the computer (according to the ID of the mouse that is connected to the computer), Furthermore, means for determining when a chat session is active over the computer are within the scope of those who are skilled in the art of Internet programming.

In the flow diagram of FIG. 9, if the ID of the mouse is found to be of a child (block 137), or if the ID is found to be unknown to the parental control application (and therefore in block 106 all restrictions are activated), a check is made to verify when a chat session is activated. In said two cases the application assumes that a child operates the computer, and it automatically sends a message to the other chat partner to warn him that he is chatting with a child. An example for such a message may be: “THIS IS A MESSAGE FROM THE PARENTAL CONTROL APPLICATION OF YOUR CHATTING PARTNER: YOU ARE WARNED THAT YOUR CHATTING PARTNER IS A CHILD, AND ARE THERFORE ADVISED TO BEHAVE ACCORDINGLY.”. Therefore, if the chatting partner does not respect this warning, and he abuses the child chatting with him, if and when he is caught he will be unable to claim that he was not aware that he was chatting with a child.

Two types of chat types are currently known. A first chat type is a stand alone program, such as MIRC. A second chat type includes those chat sessions which are activated directly from Internet sites. It is of course necessary for the application to determine if and when a chat session is active, and accordingly send a message (if the user of the computer is a child). As said, it is within the skill of those who are familiar with Internet programming to know whether a chat session is active. If the chat program is a stand alone local application, which is activated from the local computer of the user, the task is easier, as this chat application may be predefined or introduced to the parental control application to follow up when it is activated. For chat sessions, which are activated from HTML pages of Internet sites, the task is slightly more complicated, but still possible. A first sign that should be checked and is characteristic to such chat session is whether Java Applets are active. Furthermore, chat sessions have other typical characteristics, such as the rate of the transfer of characters between the session partners etc. Those who are skilled in the art may find and apply other characteristics of chat sessions, for determining whether or when a chat session is active.

Currently, attaching a mouse to a personal computer is carried out via a socket at the rear of the computer. When implementing the present invention, the mouse is likely to be plugged in and out more often than is usually the case in standard computer operations. Since approaching the rear side of the computer is inconvenient, preferably according to the invention, the mouse is designed to include a socket for its cable, in addition or in substitute to the socket on rear entry.

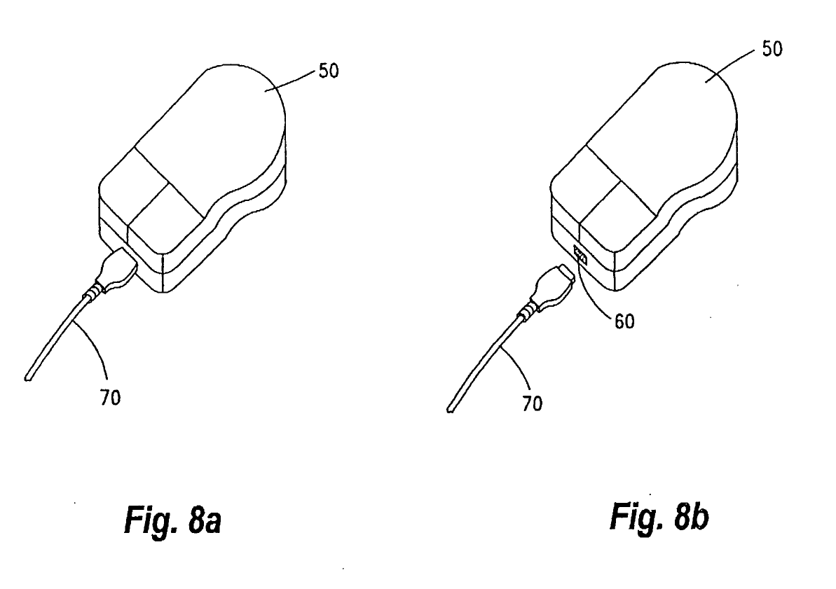

FIGS. 8a and 8b illustrate a mouse that comprises a socket 60 according to a preferred embodiment of the invention. The data cable 70, upon which the information is passed from mouse 50 to the computer, can be plugged in and pulled out from the socket 60 of the mouse 50. In this way, switching from one mouse to another becomes an easy procedure. In the regular form, the cable 70 is a part of mouse 50.

In the above embodiments, the mouse is used as an identification means. Hence, the parent should keep his mouse in a safe place in order to prevent the child from accessing predefined types of Internet sites. Due to the size of the mouse, it is not practical to carry it in a pocket but preferable to store it in a safe place, such as a locked drawer.

According to still another embodiment of the invention, a small portable and replaceable device is provided on which the ID of the mouse is stored. Using such a replaceable device may eliminate the need to hold the mouse in a safe place and the need to install a new mouse whenever the parent or child operates the computer.

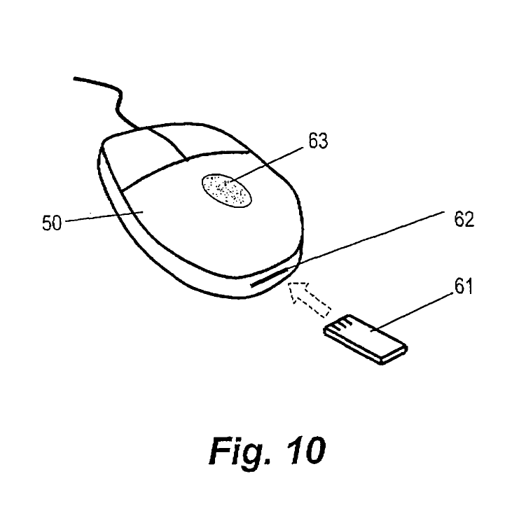

FIG. 10 schematically illustrates a mouse 50 of the invention, comprising a card 61, on which the ID is stored within its circuitry, according to an embodiment of the present invention. The electronic card 61 is installed into mouse 50 by plugging it in socket 62.

According to this embodiment of the invention, a dedicated card 61 is provided at least to the parent with a specific ID on it, different than the ID of the child.

Upon checking the current ID of the mouse, the mouse's circuitry reads the ID from the electronic card 61, and conveys it to the host computer (via the means that connect the mouse with the host computer), as described above.

While the mouse 50 is too big to be stored in a wallet, the electronic card 61 is small, and therefore suitable for stowing in a wallet, pocket, and so forth, and its presence does not bother the parent.

Preferably, the mouse further comprises an indicator 63, which lights or blinks whenever the card 61 of the parent is installed into the mouse alerting the parent that the parent less restricted setup is active. Of course other operation schemes can be implemented, such as a red color whenever the parent's ID is indicated, and a green color whenever the parent's ID is not installed, and so forth.

Those skilled in the art will appreciate that there is a variety of ways of embedding an ID in an electronic card. One familiar way is a SIM (Subscriber Identity Module), such as the SIM used in mobile telephones. Hereinafter when the term UIDM (User ID Module) is used, it should be noted that it refers to any type of a card containing memory storing an ID, similar to a SIM card.

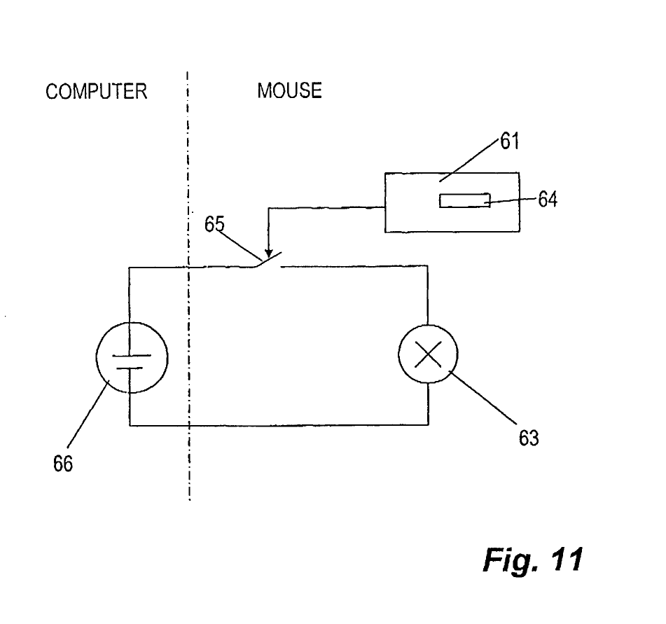

FIG. 11 illustrates a circuit for indicating the presence of the parental ID in a mouse, according to one embodiment of the invention. Upon inserting the electronic card 61 into the mouse, switch 64 is pressed, and the circuit 65 is closing. The power 66, which its source is from the computer, turns on the led 63, upon which the parent is able to notice that the setup of the parent is active.

It should be noted that there may exist two types of cases:

1. If the mouse includes an integrated ID in it, the insertion of the card (UIDM) causes overlap of the mouse ID so that the ID of the card will be read by the computer, however only the ID of the card will be read by the computer.

2. In another alternative both the ID of the mouse and the ID of the card when inserted will be read by the computer, however only the ID if the card will indicate to the setup who is using the computer, and what restrictions to apply.

According to still another embodiment of the present invention the system including a UIDM card insertable to the mouse of the computer, together with its associated setup can be used to restrict a user from accessing various applications or data, may it be local (i.e., within the PC of the user, or remote (e.g., over the local network or over the Internet). More particularly, the system with a minor modification can also be used as a security means, when UIDMs with personal IDs are distributed to different users.

For example, since a computer may comprise important material to the parent, some operations such as deletion or accessing files may be restricted to the case when the parent's ID is inserted in the mouse system.

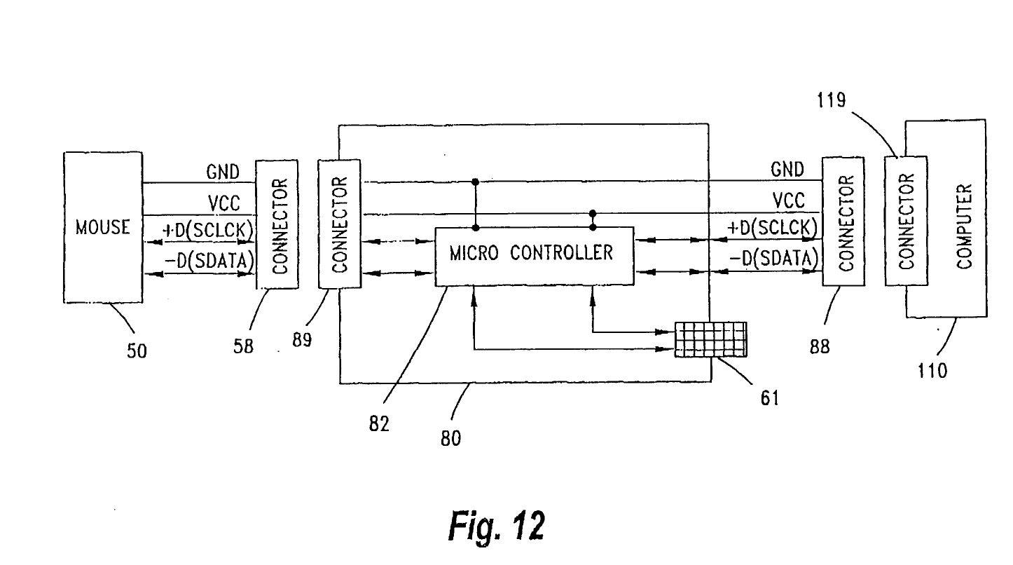

FIG. 12 schematically illustrates an “identification” box, according to one embodiment of the invention. The “identification” box 80 is inserted between the mouse 50 and computer 110. The identification box 80 comprises a connector 88, which connects the identification box 80 to the computer 110.

The connection between the mouse and the identification box is carried out by the connector 58 of the mouse and the connector 89 of the identification box. The connection between the identification box 80 and the computer is carried out by the connector 88 of the identification box and the connector 119 of the computer 110. The connectors are of the types PS/2 or USB.

The Identification box deals with the common protocols of connecting a mouse to a computer system, PS/2 and USB. These protocols use 4 wires to connect the mouse to the computer:

The VCC and GND, which are used for the power source to the mouse;

The +D and −D or SDATA and SCLCK, which are used for conveying data between the mouse and the computer, including acknowledgments and control.

The identification box enables to the connected mouse to operate “transparently”, i.e. the mouse and the hosting computer are operating like no identification box was connected to the system.

The identification 80 box comprises a socket for inserting the ID card 61. In addition, the identification box is able to read or write the content of the ID card 61. Those skilled in the art will appreciate that currently the use UIDM-writers is very common.

By the microcontroller 82, the identification box 80 intercepts data transferred between the mouse and the hosting computer, and interferes whenever it is needed. Moreover, the software element 100 (as seen in FIG. 2) can communicate with the microcontroller 82.

Typically, the microcontroller periodically checks the presence of the ID card 61, and if the card is not present or the ID is not the parent's ID, the software element 100 forces the most severe restrictions, according to the Parental Control setup.

The benefits of using the identification box over the socket inside the mouse is:

The user (parent or child) is not limited to the mouse with the socket, but can use any type of mouse;

Since the identification box can alter the content of the ID card, a plurality of ID cards can be issued (usually by the parent), each of which with a different Parental Control scheme.

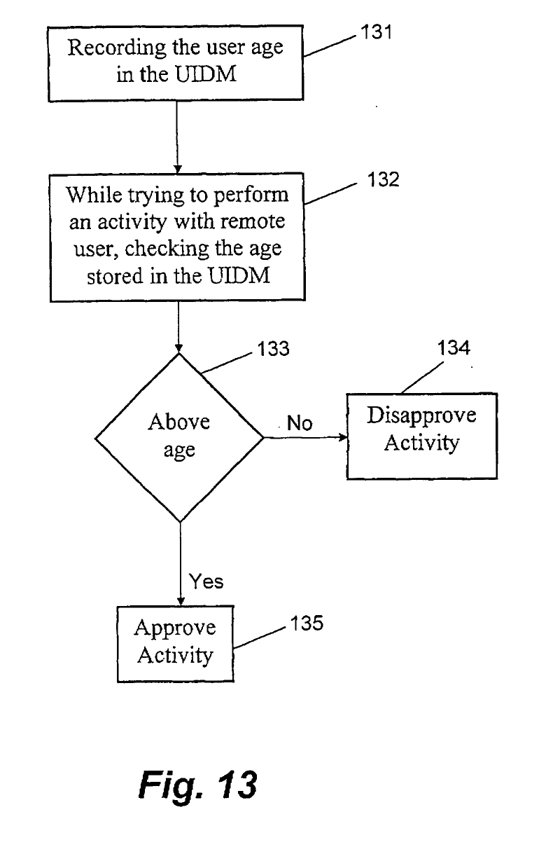

According to another embodiment of the invention, the age of the user is recorded in the UIDM. The recorded age is used to approve/disapprove activities with remote users, such as while shopping in the Internet, entering into adults chat etc. FIG. 13 schematically illustrates in a flowchart form an age based approval/disapproval sequence. The flowchart starts at block 131, wherein the user age is recorded into the user's UIDM 61 and then the UIDM 61 is stored in the user's mouse. At the next step, block 132, whenever a user is trying to perform an activity with a remote user, a checking is made by the application of said remote user or by the local application the age stored in the UIDM 61. At the next step, block 133, the age of the user is checked or compared with a required threshold age for performing the activity or not, as is defined. If however, the age is above the threshold, then at the next step, block 135, the activity is approved. If the age is below the threshold, then the activity is disproved (block 134). For example, adults sites may be forced to check the age of the user, as recorded on its UIDM 61, and if the age is found below a threshold age (e.g., below 21), the activity is terminated.

It should be noted that registration of the age on the UIDM 61 should be restricted only to authorized people that register the age only after restriction. For example, only the dealer who sells the UIDM may be allowed to register the age. Moreover, the age may be registered only by using a suitable encrypted system.

In similar manner, the age of the mouse user is recorded within the “identification” box 80 (shown in FIG. 12) or within the personal mouse of the user.

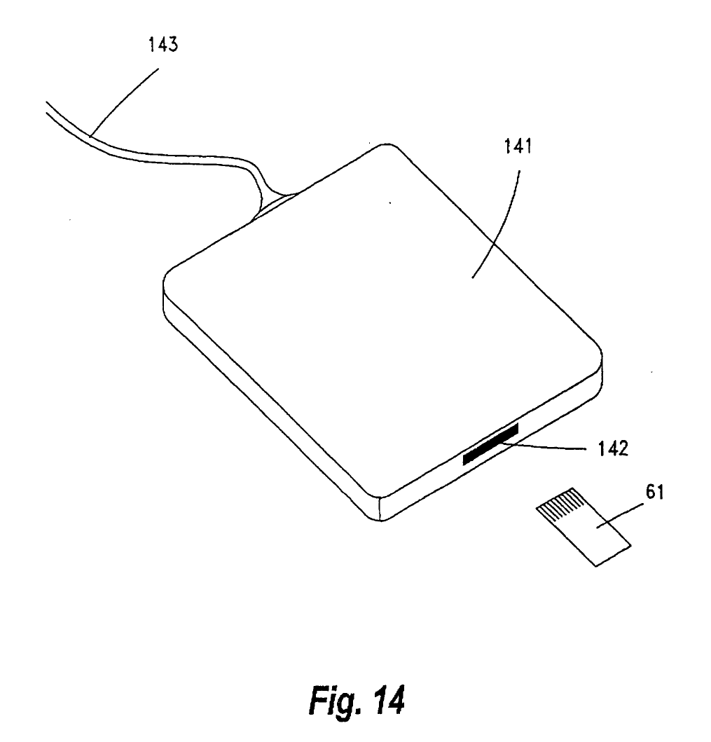

In still another embodiment of the invention, the UIDM 61 is inserted into a slot within the mouse pad having UIDM reading capability. For example, FIG. 14 illustrates a mouse pad 141 with UIDM reading capability. UIDM 61 is inserted into UIDM slot 142. The mouse pad is connected by cable 143 to the computer. Cable 143 can use any suitable connection protocol, such as USB, PS/2 etc.

While some embodiments of the invention have been described by way of illustration, it will be apparent that the invention can be carried into practice with many modifications, variations and adaptations, and with the use of numerous equivalents or alternative solutions that are within the scope of persons skilled in the art, without departing from the spirit of the invention or exceeding the scope of the claims.

1. A method for carrying out Parental Control when browsing the Internet by means of a computer, comprising:
a) Providing a Parental Control application;
b) Providing in said parental control application several setups, each setup including predefined restrictions for accessing Internet sites or Web pages;
c) Providing at least two mouse components, each mouse component having its unique ID;
d) Associating with each mouse component one or more of said setups;
e) When operating the computer for browsing the Internet, activating said Parental Control application;
f) Retrieving by said application the ID of the mouse component connected; and
g) Activating by said application the setup associated with the ID of said mouse component, thereby activating its corresponding Internet access restrictions.

2. A method according to claim 1, wherein the Parental Control application is a module of the Internet browser.

3. A method according to claim 1, wherein the Parental Control application is a module separate from the Internet browser.

4. A method according to claim 1, wherein the ID of the mouse component is a unique ID stored in a memory storage within the mouse.

5. A method according to claim 1, wherein a first of said at least two mouse component is given to a parent, and a second is given to a child.

6. A method according to claim 5, wherein the setup associated with the ID of the parent mouse component includes less restrictions than those in the setup of the child's mouse, or null restrictions.

7. A method according to claim 1, wherein the mouse component is a mouse.

8. A method according to claim 7, wherein the parent's mouse differs in shape and/or color from the child's mouse.

9. A method according to claim 8, wherein the differences in shape and/or color between the parent's mouse and the child mouse are so significant as to be easily noticed even from a considerable distance.

10. A method according to claim 1, wherein the ability to define the restrictions in the setups is restricted.

11. A method according to claim 1, wherein defining the restrictions in the setups is restricted by a password.

12. A method according to claim 1, wherein associating of setups to a mouse ID is restricted.

13. A method according to claim 1, wherein associating setups to a mouse ID is restricted by a password.

14. A method according to claim 1, wherein the mouse component of the parent is kept in a safe place inaccessible to the child, when not in use.

15. A system for carrying out parental control which comprises a parental control application, and at least two mouse components.

16. A system according to claim 15, wherein the parental control application comprises several setups, each setup including predefined restrictions for accessing Internet sites or Web pages.

17. A system according to claim 16, wherein the mouse component comprises an ID and the parental control application comprises software means for retrieving said ID.

18. A system according to claim 15, wherein the mouse component is a mouse.

19. A system according to claim 16, wherein each mouse comprises a first plug to which a second plug in the cable leading to the computer is connected.

20. A system according to claim 17, wherein said first plug is located within the case of the mouse.

21. A system according to claim 18, wherein said first plug is located external to the mouse casing, several centimeters therefrom, a data cable connecting between said first plug and the mouse.

22. A method according to claim 1, further comprising the steps of:
a) Defining a “child” user according to the ID of the mouse component he uses;
b) Determining when a chat session is activated by said “child” user; and
c) Sending a message to the chat partner of said “child” user to warn him that he is chatting with a child.

23. A system according to claim 17, further comprising:
a) Means in said parental application for defining a “child” user;
b) A warning message for warning a chat partner that he is chatting with a child.
c) A module within said parental application for determining when a chat session is activated by said “child” user, and for sending said warning to said chat partner when such session is found active.

24. A system according to claim 23, wherein the warning message is a predefined message being an integral part of the parental control application.

25. A system according to claim 23, wherein the warning message is a message which is predefined by an adult user of the computer.

26. A method according to claim 1, wherein:
a) the mouse components are at least one UIDMs connectable to the mouse system of the computer, each UIDM having its unique ID;
b) Associating with each UIDM one or more of the setups;
c) When operating the computer for browsing the Internet, activating said Parental Control application;
d) Retrieving by said application the ID of the UIDM connected to the mouse of the computer; and
e) Activating by said application the setup associated with the ID of said UIDM, thereby activating its Internet access restrictions.

27. A method according to claim 26, wherein the Parental Control application is a module of the Internet browser.

28. A method according to claim 26, wherein the Parental Control application is a module separate from the Internet browser.

29. A method according to claim 26, wherein the ID of the UIDM is a unique ID stored in a memory storage within the UIDM.

30. A method according to claim 26, wherein a UIDM is given to a parent, and the UIDM is connected to the mouse only when the parent is working on the computer, and removed at other times.

31. A method according to claim 30, wherein the setup associated with the ID of the parent UIDM includes less restrictions than those in the setup of a child's UIDM, or null restriction.

32. A method according to claim 30, wherein the most restricted setup is activated when no UIDM is connected to the mouse.

33. A method according to claim 32, wherein the mouse system further comprises a light indicator that lights when a UIDM is connected to the mouse system or alternatively lights when a UIDM is not connected to the mouse system.

34. A method according to claim 26, wherein the ability to define the restrictions in the setups is restricted.

35. A method according to claim 26, wherein defining the restrictions in the setups is restricted by a password.

36. A method according to claim 26, wherein the associating of setups to a UIDM ID is restricted.

37. A method according to claim 26, wherein associating setups to a UIDM ID is restricted by a password.

38. A method according to claim 31 wherein the UIDM of the parent is kept in a safe place inaccessible to the child, when not in use.

39. A method according to claim 26, wherein the UIDM is connected by inserting it into a slot within the mouse system.

40. A method according to claim 26, wherein the mouse system comprises a mouse connectable to the computer and a slot, wherein the UIDM is connectable to a slot within the mouse.

41. A method according to claim 26, wherein the mouse system comprises a mouse and an identification box connectable to said mouse and computer, and wherein the UIDM is connectable to a slot within said identification box.

42. A method according to claim 26, wherein the UIDM is connected by inserting it into a slot within a mouse pad.

43. A system for carrying out parental control which comprises a parental control application, and at least one UIDM connectable to the mouse system of the computer.

44. A system according to claim 43, wherein the parental control application comprises several setups, each setup including predefined restrictions for accessing Internet sites or Web pages.

45. A system according to claim 43, wherein the UIDM comprises an ID and the parental control application comprises software means for retrieving said ID.

46. A method for carrying out Security Control when browsing the Internet by means of a computer, comprising:
a) Providing a Security Control application;
b) Providing in said Security control application several setups, each setup including predefined restrictions for accessing data from a computer;
c) Providing at least one UIDM connectable to the mouse system of the computer, each UIDM having its unique ID;
d) Associating with each UIDM one or more of said setups;
e) When operating the computer, activating said Security Control application;
f) Retrieving by said application the ID of the UIDM connected to the mouse system of the computer; and
g) Activating by said Security Application the setup associated with the ID of said UIDM, thereby activating the security restrictions associated with said UIDM.

47. A method according to claim 46, wherein the ID of the UIDM is a unique ID stored in memory storage within the UIDM.

48. A method according to claim 46, wherein different UIDMs are given to different users, and the UIDM is connected to the mouse system only when the user is working on the computer, and removed at other times.

49. A method according to claim 46, wherein the mouse system further comprises a light indicator that lights when a UIDM is connected to the mouse system or alternatively lights when a UIDM is not connected to the mouse system.

50. A method according to claim 47, wherein the ability to define the restrictions in the setups is restricted.

51. A method according to claim 46, wherein defining the restrictions in the setups is restricted by a password.

52. A method according to claim 46, wherein associating of setups to a UIDM ID is restricted.

53. A method according to claim 46, wherein associating setups to a UIDM ID is restricted by a password.

54. A method according to claim 46 wherein the UIDM of the computer user is kept in a safe place inaccessible to other, when not in use.

55. A method according to claim 46, wherein the UIDM is connected by inserting it into the slot within the mouse system.

56. A system for carrying out security control which comprises a security control application, and at least one UIDM connectable to the mouse system of the computer.

57. A system according to claim 56, wherein the security control application comprises several setups, each setup including predefined restrictions for accessing data from said computer.

58. A system according to claim 56, wherein the UIDM comprises an ID and the security control application comprises software means for retrieving said ID.

59. A system according to claim 56, wherein the mouse system comprises a mouse connectable to the computer and a slot wherein the UIDM is connectable to a slot within the mouse.

60. A system according to claim 56, wherein the mouse system comprises a mouse connectable to the computer and a slot wherein the UIDM is connectable to a slot within the mouse pad.

61. A system according to claim 56, wherein the mouse system comprises a mouse and an identification box connectable to said mouse and computer, and wherein the UIDM is connectable to a slot within the mouse.

62. A method according to claim 1, wherein the age of the user is recorded within the mouse component, which can be retrieved from the mouse component by a remote application with which the user is remotely connected.
